(19) United States
(12) Patent Application Publication
(10) Pub. No.: US 2003/0135406 A1
(43) Pub. Date: Jul. 17, 2003

(54) Method and apparatus for identifying cash leakage

(76) Inventor: John J. Rowe, St. Joseph, MO (US)

Correspondence Address: HOVEY WILLIAMS LLP, Suite 400, 2405 Grand, Kansas City, MO, 64108, US

(21) Appl. No.: 10/044,228

(22) Filed: Jan. 11, 2002

(51) Int. Cl. G06F 17/60

(52) U.S. Cl. 705/11

(57) ABSTRACT

A computer-implemented method and computer program for use with a cash register that tracks individual transaction data by employee to help identify unusual patterns that are indicative of employee theft. The computer program allows the tracking of certain transaction data by individual employee and comparison of that data to other employees and/or the same employee time shifts from different days. By tracking and comparing relevant transaction data, unusual or suspicious patterns of activity can be identified and thereafter investigated by the employer to determine whether dishonest activities are occurring. The program also maintains a cash inventory, records denominations tendered in payment for goods or services, and indicates the exact denominations to tender as change.

A computer program listing appendix containing the source code of a computer program that may be used with the present invention is incorporated herein by reference and appended hereto as one (1) original compact disk, and an identical copy thereof, containing a total of 13 files as follows:

| | | |
|---|---|---|
| Filename | Size/Type | Modified |

Directory of Speedy D:\

| | | |
|---|---|---|
| Comm | File Folder | Dec. 18, 2001 1:21 PM |
| Pump | File Folder | Dec. 18, 2001 1:21 PM |
| credit.prg | 44 KB/PRG File | Dec. 17, 2001 9:56 AM |
| register.prg | 790 KB/PRG File | Dec. 18, 2001 1:37 PM |
| report.prg | 146 KB/PRG File | Dec. 17, 2001 2:13 PM |

Directory of Speedy D:\Comm

| | | |
|---|---|---|
| comm.c | 45 KB/C File | Aug. 14, 2001 8:11 AM |

Directory of Speedy D:\Pump

| | | |
|---|---|---|
| dlldata.c | 1 KB/C File | Oct. 7, 1999 4:36 PM |
| Pump1.cpp | 10 KB/CPP File | Sep. 1, 1999 11:33 AM |
| pump95.c | 25 KB/C File | Aug. 17, 2001 2:08 PM |
| pumplib.c | 255 KB/C File | Nov. 5, 2001 10:00 AM |
| PumpNT.cpp | 3 KB/CPP File | Sep. 1, 1999 11:33 AM |
| PumpNT_i.c | 2 KB/C File | Oct. 7, 1999 4:36 PM |
| PumpNT_p.c | 31 KB/C File | Oct. 7, 1999 4:36 PM |

### FIELD OF THE INVENTION

The present invention relates to a method and apparatus for detecting and identifying employee theft. More particularly, the invention relates to a computer-implemented method and computer program capable of tracking individual cash register transaction data by employee, comparing employee performance based on that data, identifying likely instances of employee theft based on the comparison, and monitoring and controlling cash inventory in the cash register.

### DESCRIPTION OF THE PRIOR ART

The actions of dishonest employees can result in a reduction of the profitability of a business. Such activities are a particular concern for retail stores that may be operating on a narrow profit margin and that may see a relatively high turnover in employees who fill the relatively low skilled position of a check-out clerk.

Common dishonest practices include directly stealing cash from an open cash register drawer and product theft. These dishonest practices have been handled adequately in the prior art by identifying shortages in the cash register as reported in employee shift reports. By identifying shortages in employee shift reports, theft from an open cash register drawer is fairly easy to identify and the probability of being caught is quite high. Furthermore, product theft has been identified and reduced through inventory control procedures such as comparing ending retail sales balances with physical inventory count balances. Retail sales balances are calculated by taking the beginning retail dollar amount plus purchases minus sales to arrive at an ending retail dollar amount. This ending retail dollar amount should match the total retail dollar amount of the physical inventory count. An ending physical inventory balance that is lower than the ending retail balance is an indication of product theft. For these reasons, these more obvious acts of employee dishonesty are relatively easy to combat and are less prevalent.

More common, and less easy to prevent, identify, and prosecute, are methods of stealing cash from the cash register where valid cash register entries can be used to disguise the theft. These methods include using the “No Sale,” “Void,” and “Refund” features of cash registers. Using the “Void” key, an employee can handle a customer transaction apparently legitimately. The employee can accept payment from the customer and then, once the customer leaves the store, void the transaction and keep the money tendered in the transaction. By voiding the transaction, the cash register record will not show the tender of the voided sale in its shift end total. The merchandise will be gone and the employee pockets the money. Similarly, an employee may “refund” a transaction after it is complete, without receiving the purchased goods back but keep the money or give part or all of the money to an accomplice or friend. This has the exact same affect as a voided sale. By using the “No Sale” key, an employee can make it appear a valid transaction has occurred when in fact it has not. Pressing the “No Sale” key opens the cash drawer and has all the appearances of a legitimate transaction thus disguising the illegal activity from others who maybe present in the store. When the “No Sale” key is pressed no sales data is recorded and the money will not be missed on an employee shift report. As with the voided sale, the employee can then pocket the money. Using any or all of these techniques, a crooked employee can avoid detection from the conventional detection method of comparing actual cash in the drawer at the end of a shift with the expected total. The expected total will not reflect the missing cash.

Thus, there is a need for a new method for tracking employee activity in order to identify acts of theft resulting in cash leakage.

### SUMMARY OF THE INVENTION

The present invention solves the above-described problems and provides a distinct advance in the field of employee theft prevention and detection. More particularly, the present invention provides a computer-implemented method and computer program for use with a cash register that tracks individual transaction data by employee to help identify unusual patterns that are indicative of employee theft.

The methods of the present invention are preferably implemented via a computer program resident in a cash register. Alternatively, the computer program may be resident in a computer linked to one or more cash registers in a local area network or via the internet or other wide area network. The computer program allows the tracking of certain transaction data by individual employee and comparison of that data to other employees and/or the same employee time shifts from different days. By tracking and comparing relevant transaction data, unusual or suspicious patterns of activity can be identified and thereafter investigated by the employer to determine whether dishonest activities are occurring.

In a preferred embodiment of the present invention, the computer implemented method broadly includes the steps of tracking by individual employee relevant sales transaction data, calculating an employee's performance with respect to the transaction data, comparing the performance data between employees and/or between similar employee shifts, and reporting the data in a manner that makes unusual activity easy to identify. In another embodiment, an employee rating system is utilized whereby an employee's shift data is compared against a predetermined number of previous shifts for the same time frame from different days to calculate variances in the employee's performance from the norm established by the predetermined number shifts. The percentage of variance from the norm for relevant categories of data is tracked and points are assigned for each variance based upon a pre-defined points table. A report may then be generated showing the employee variances, total points per day, and average points per week for each employee. This report will help store management to quickly spot problems in employee performance and take appropriate action in response. These reports may also be published to the employees to help deter dishonest practices by making the employees aware that this information is being tracked.

In another embodiment the cash inventory in a cash register is carefully tracked by denomination. The operator inputs the exact denominations received as tender during a transaction and the cash register displays the exact denominations to tender as change in completing the transaction. Thus, the cash inventory can be closely monitored and controlled.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIGS. 1a-1d show in block diagram form alternative embodiments of the computer hardware necessary to operate the present invention;

FIG. 2 is a sample graph output from one embodiment of the present invention;

FIG. 3 is a sample graph output from one embodiment of the present invention;

FIG. 4 is an example employee report output by one embodiment of the present invention;

FIG. 5 is a flow diagram of a portion of one embodiment of the computer program of the present invention; and

FIG. 6 is an example cash inventory screen of one embodiment of the computer program of the present invention.

### DETAILED DESCRIPTION OF THE PREFERRED EMBODIMENTS

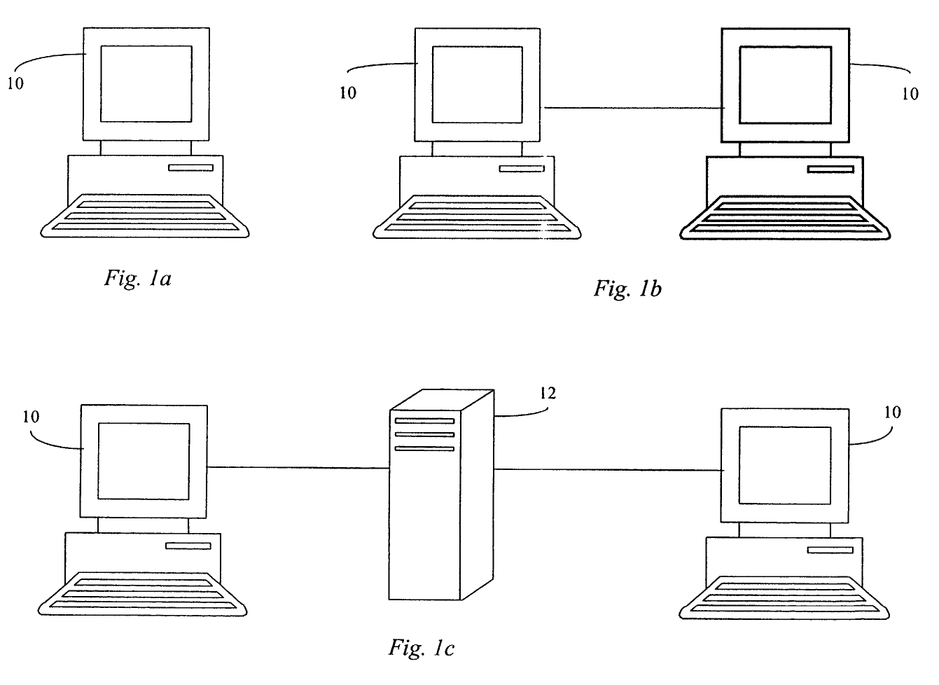

The computer program and method of the present invention are preferably implemented with computer equipment such as the alternative hardware embodiments shown in FIGS. 1a-1d. In the embodiment of FIG. 1a, a cash register 10 has the computer program of the present invention resident in its memory. Presently, cash registers such as cash register 10 comprise personal computers specially configured for the cash register function. Although the embodiment of FIG. 1a shows a single cash register 10, it is also possible for a single store to have a plurality of cash registers 10 each operating on a stand alone basis and each having its own version of the computer program of the present invention.

In the embodiment of FIG. 1b, two cash registers 10 are linked together. In this embodiment, either or both of the cash registers 10 may operate the computer program of the present invention. If both cash registers operate the program, they each record the relevant transaction data and are capable of reporting that data as further described below. If only one of the cash registers 10 has the computer program resident on it, the other cash register reports all relevant data to the first through the connection between them.

In the embodiment of FIG. 1c, two cash registers 10 are linked through a local area network to a server 12. In this embodiment, the server 12 contains the computer program of the present invention and the individual cash registers 10 report the relevant transactional data to the server 12 over the local area network.

In the embodiment of FIG. 1d, two cash registers 10 are linked through a wide area network (WAN) 14, such as the Internet, to a server 16 that is also connected to WAN 14. In this embodiment, server 16 contains the computer program of the present invention and cash registers 10 report relevant transactional data to server 16 through WAN 14. In the embodiment of FIG. 1d, each cash register 10 may have its own connection to the wide area network 14, or alternatively, each cash register 10 may connect through a local area network to a server, such as server 12 of FIG. 1c, server 12 then connects to WAN 14. In the alternative embodiments of FIGS. 1c and 1d, it is also possible for each cash register 10 to run its own stand alone version of the computer program and report results to server 12, in the case of embodiment 1c, and to server 16, in the case of embodiment id. For each of FIGS. 1b-1d, although only two cash registers are shown, any number of cash registers may be employed. The computer equipment described and illustrated herein may be replaced with other conventional computer equipment without departing from the scope of the invention.

In the preferred embodiment, a cash register 10 will be assigned to be used by a specific employee throughout a given shift. The employee will sign in and be identified by the computer program associated with the particular cash register used by the employee at the time at the beginning of a shift. This identification may be done, for example, by requiring the employee to enter a personal identification number (PIN) associated with that employee in order to make the cash register operate. Once the employee has signed in with a PIN, the cash register will track relevant transaction data that is useful for identifying dishonest employee tactics throughout the shift. The data is stored in a memory in the cash register or other linked computer. The computer program operates a relational data base comprising tables that store various fields of transactional data and also track date, time, and employee identifying information. It is important that the employee operating the cash register properly sign in at the beginning and sign out at the end of the shift. This ensures that transactional data is properly recorded and associated with the employee who handles the transaction.

In one preferred embodiment of the present invention the data to be tracked is particularly relevant for a convenience store operated in conjunction with the retail sale of gasoline. In the setting of a convenience store and gas outlet, the following types of tracking information have been found useful:

Overages and shortages—tracks discrepancies in actual cash drawer balances as compared to the expected balance recorded by the cash register.

Average “no sales” per customer—tracks the average number of no sales per customer serviced.

Average of voids per customer—tracks the average number of voids per customer serviced.

Average refunds per customer—tracks the average number of refunds per customer serviced.

Average void amount per customer—tracks the average dollar amount of voids per customer serviced.

Average refund amount per customer—tracks the average dollar amount of refunds per customer serviced.

Average customers per hour—tracks the average number of customers serviced per shift hours worked.

Average number of gallons of gasoline per hour—tracks the average number of gallons of fuel sold per shift hours worked.

Average taxable sales per customer—tracks the average dollar amount of taxable sales per customer serviced.

Average taxable sales per hour—tracks the average dollar amount of taxable sales per shift hours worked.

Average sales with fuel—tracks the average dollar amount of sales that include fuel.

Average taxable sales—tracks the average taxable sales per shift, which excludes gasoline, lottery, lottery paid out, coupons, money orders and utility payments that can vary greatly on a per customer basis.

Average cigarette units per customer—tracks the average number of cigarette units sold per customer serviced.

Cigarette volume—tracks the volume of cigarette units as a percentage of taxable sales.

Average percent of lottery sales—tracks the average dollar amount of lottery sales as against total sales.

Average time per transaction—tracks the average length of time it takes to complete a transaction by recording how long the cash drawer is open.

The above data may then be analyzed to spot discrepancies or patterns that indicate dishonest activity by an employee. For instance, large shortages are an indication that an employee is stealing money from the cash drawer. Large numbers of “No Sales” are an indication of possible theft. This is because a transaction can be completed apparently legitimately without recording that tender from the transaction should be deposited in the drawer. The employee can then pocket the money. However, “No Sales” transactions are not always indicative of theft because there are legitimate reasons for a “No Sales” transaction. For instance, if a customer is seeking change the “No Sales” button should be depressed to open the cash drawer to complete the transaction. Thus, “No Sales” activities are merely an indicator of theft.

Likewise, large numbers of “Voids” and “Refunds” are an indication of theft. Because these transactions have legitimate purposes too, the data that is tracked is most useful when making relative comparisons between different employees and when comparing the same shift or time period between days. Thus, if there is a large variation in the number of customers serviced by a given employee during a particular time shift when compared to other employees during the same time shift on other days, this may be an indication that disguised theft is occurring.

Certain transaction data items have been found particularly useful to track as an indicator of dishonest activity in a convenience store and gas station outlet. For example, tracking large variances related to fuel sales, cigarette sales, and lottery ticket sales have been found to be indicative of theft. Additionally, tracking the average time per transaction is useful in any retail setting. Large variations in this figure are an indication of theft because a dishonest employee will take longer to complete a transaction or will have the cash drawer open longer than an employee who is honestly performing his or her duties.

After employee transactional data is collected, reports and graphs can be generated on an individual employee basis comparing the employee's data for one or more of the above categories with average or normalized information for all employees in an employee-to-employee comparison or employee to average shift comparison. The graphical information makes suspicious variances readily apparent and can indicate that a particular employee should be watched more carefully and that information regarding particular shifts should be gathered.

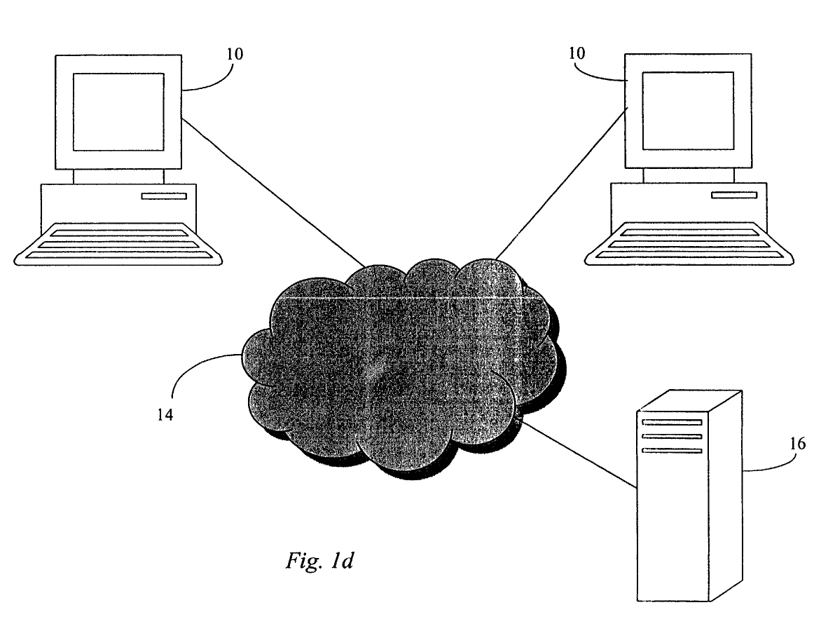

Turning to FIG. 2, a typical graph showing recorded transaction data for different employees is shown. In FIG. 2, overages and shortages are graphed. Thus, the vertical axis 20 of the graph shows dollar amounts and the horizontal axis 22 displays different employees. The dollar amounts represented on the vertical axis 20 are the total difference between the actual cash in the cash drawer at the end of a shift as compared to the amount of cash expected based on cash register data. If more cash is present in the drawer than is expected by the cash register data this is recorded as an overage. If less cash is in the drawer than expected by the cash register data this is recorded as a shortage.

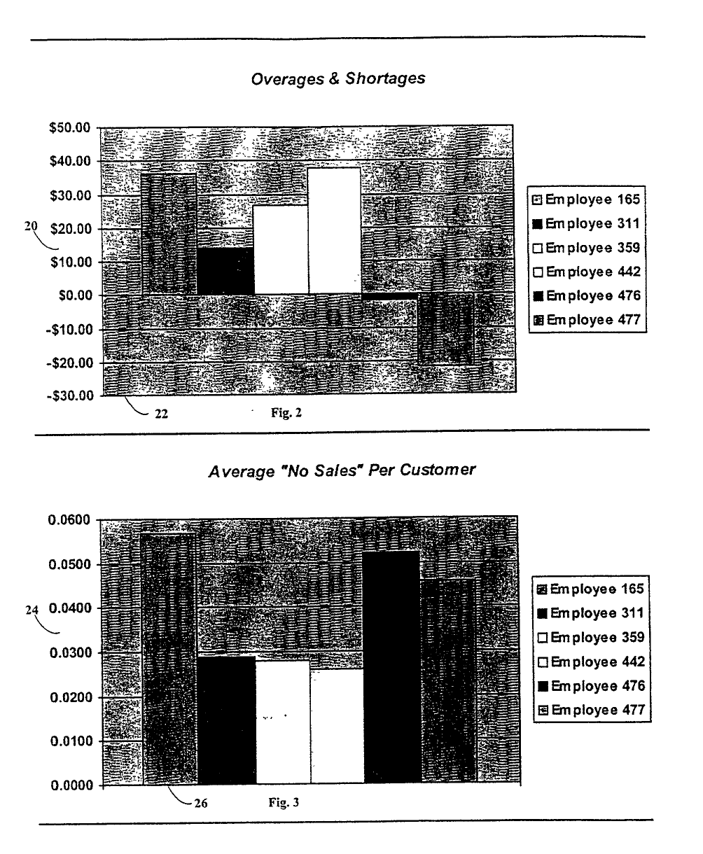

In the graph of FIG. 3 average “No Sales” per customer are shown. The vertical axis 24 records the average number of “No Sales” per customer and the horizontal axis 26 shows different employee entries for this data type. Thus, in the graph of FIG. 3, Employee 165 averaged greater than 0.05 “No Sales” per customer while Employee 442 averaged approximately 0.025 “No Sales” per customer. This variance may be a strong indicator that Employee 165 should be monitored for possible theft. The graphs of FIGS. 2 and 3 help store managers spot unusual transaction activity and provide an indicator of employee theft which allows for further investigation by the store manager. Although only two of the transaction data types are shown graphed in FIGS. 2 and 3, any of the above referenced transaction data types may of course be graphed.

In addition, in one embodiment of the invention an employee rating system is used based upon one or more of the above identified categories of information. In this embodiment, data from one employee's shift is compared against the same shift from the last ten days and variances in the employee's performance are calculated as against the ten shift average. The program allows tracking the percentage of variance from the norm for each category and then assigns points for each variance based upon a pre-defined points table. While any point system may be developed that is useful to identify significant variances, table 1, set forth below is one proposed point system.

TABLE 1

| Category | 1 point | 2 point | 3 point | 4 point |
|---|---|---|---|---|
| tardy | 1 to 15 min | 16 to 30 | 31 to 60 | >60 |
| short/long cash | −/+ > $1 | >$1<$5 | >$5<$10 | >$10 |
| voids | >5%<10% | >10%<15% | >15%<25% | >25% |
| no sales | >5%<10% | >10%<15% | >15%<25% | >25% |
| refund amount | >5%<10% | >10%<15% | >15%<25% | >25% |
| void amount | >5%<10% | >10%<15% | >15%<25% | >25% |
| average sales w/o | >5%<10% | >10%<15% | >15%<25% | >25% |
| gas | | | | |
| average totals sales | >5%<10% | >10%<15% | >15%<25% | >25% |
| w/o notax | | | | |
| average % cigarette | >5%<10% | >10%<15% | >15%<25% | >25% |
| sales to total sales | | | | |
| average lottery | >5%<10% | >10%<15% | >15%<25% | >25% |
| sales/customer | | | | |
| days w/paper | <15% | >15%<30% | >30%<50% | >50% |
| mistakes/days wk | | | | |
| % of no's from a | <20% | >20%<30% | >30%<40% | >40% |
| three job list at end | | | | |
| of shift/days worked | | | | |

The percentages represent the variance from a normalized value. The normalized value is the average for the last 10 same day and time shifts as the shift that is being reported on. (The average is of all registers open for that time frame).

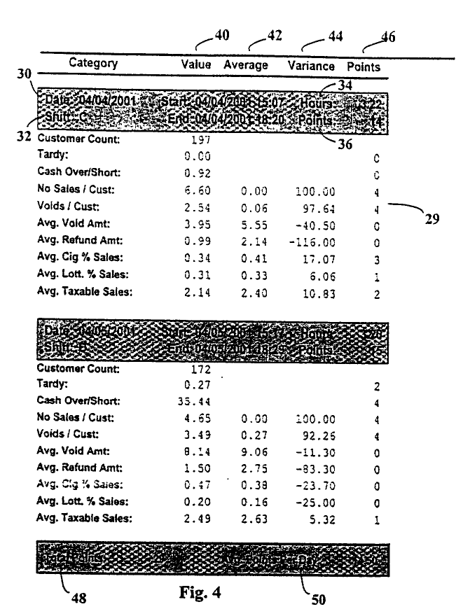

The program will then generate a report showing employee variances, total points per day and average points per week for each employee. FIG. 4 shows an example of such an employee report. In the report of FIG. 4, each of an employee's shifts worked during a single week are displayed. Each day has its own table 29. Each table 29 includes a date indicator 30, a shift indicator 32, total hours worked for date 34, and total points for the shift 36. Sample tracked data categories are identified in the left hand column of table 29. Following each data type are three columns representing the value 40 for the particular shift, the average of that value 42 over the last 10 shifts from this time period, and the variance 44 of the present shift value from the average. There is a final column 46 in which the points listed for the variance for the particular row are assigned. At the bottom of the report the total points for the week 48 are shown as well as the average points per day 50. In the particular example of FIG. 4 the assigned points are based on the points system set forth in table 1. Of course, any point system may be developed to track performance without departing from the scope of the invention. Likewise, the average can be based on greater or fewer numbers of shifts without departing from the scope of the invention.

The employee rating figures may also be included on a payroll report submitted to a payroll department. This will help store managers to quickly spot problems in employee performance and allow managers to take timely disciplinary action as appropriate. It is also possible to generate an employee summary for each employee on a weekly basis. This information may be provided to the employee to allow employees to track their own performance and to serve as a deterrent to dishonest practices by making employees aware of the type of information that the employer is tracking.

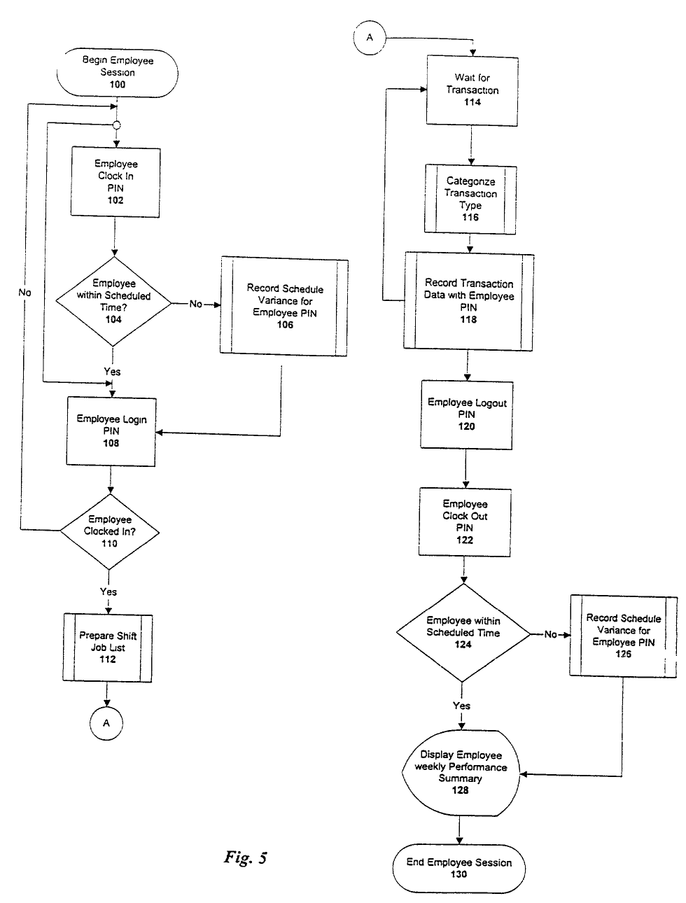

FIG. 5 shows a flow chart of one embodiment of the present invention in which the computer program operates real time to record cash register transaction data during an employee's shift. The program begins at step 100 with the beginning of an employee's session. At step 102 an employee clocks in to start a shift with a personal identification number. This PIN will be used as an identifier for the employee when transaction data is saved later to a database. At step 104 the program tests to determine if the employee clocked in at the time scheduled for the shift. If the employee did not clock in at the expected time, program control proceeds to step 106 where the time variance is recorded for the employee PIN. At step 108 the employee logs in using the PIN. The program then checks to ensure the employee has clocked in at step 110 and returns to step 102 if not. At step 112 the program prepares a shift job list of tasks to be completed around the store during slow business periods. The list may be selected at random from tasks entered by a manager. At step 114 the program waits for a transaction to occur at the cash register. Because the cash register drawer will only open when a transaction is occurring, there is no danger of theft from the cash register drawer without a transaction of some type being recorded. Once a transaction occurs, the program proceeds to step 116 where the transaction data is categorized. At step 118 the data is recorded and identified with the employee's PIN. The categorized data is stored at step 118 in a relational database that contains a plurality of tables holding the relevant record data. Each table within the relational database maintains the employee PIN associated with each record to allow later reporting by employee. Once step 118 is complete, the program then loops back to step 114 and waits for another transaction. This loop will continue until it is broken at step 120 when the employee ends the session by logging out and then clocking out at step 122. After the employee has logged out and clocked out, the program proceeds to step 124 where the program tests to determine if the employee clocked out within the scheduled time. If the employee did not clock out within the scheduled time, program flow proceeds to step 126 where the schedule variance is recorded for the employee PIN. After the employee has logged out and clocked out and the program has determined whether a schedule variance occurred, program flow proceeds to step 128 and displays the employee weekly performance summary. The employee session then ends at step 130. The program will then return to step 100 where it awaits another valid login. In another embodiment, the employee can be asked to indicate at the end of a session which jobs from the shift job list were completed. A manager can then later inspect the store to determine whether the jobs were completed and the quality of the work performed by the employee in completing those jobs. These results can also be incorporated into the employee database and reported on and assigned points as part of the employee evaluation.

The program creates and maintains the database of cash register transaction data throughout operation of the cash register. The database will be limited by the amount of memory that can be devoted to its function. Thus, a particular store operator can select to maintain historical data for as short or as long as desired limited only by the size of the hard drive or other memory media employed to maintain the database.

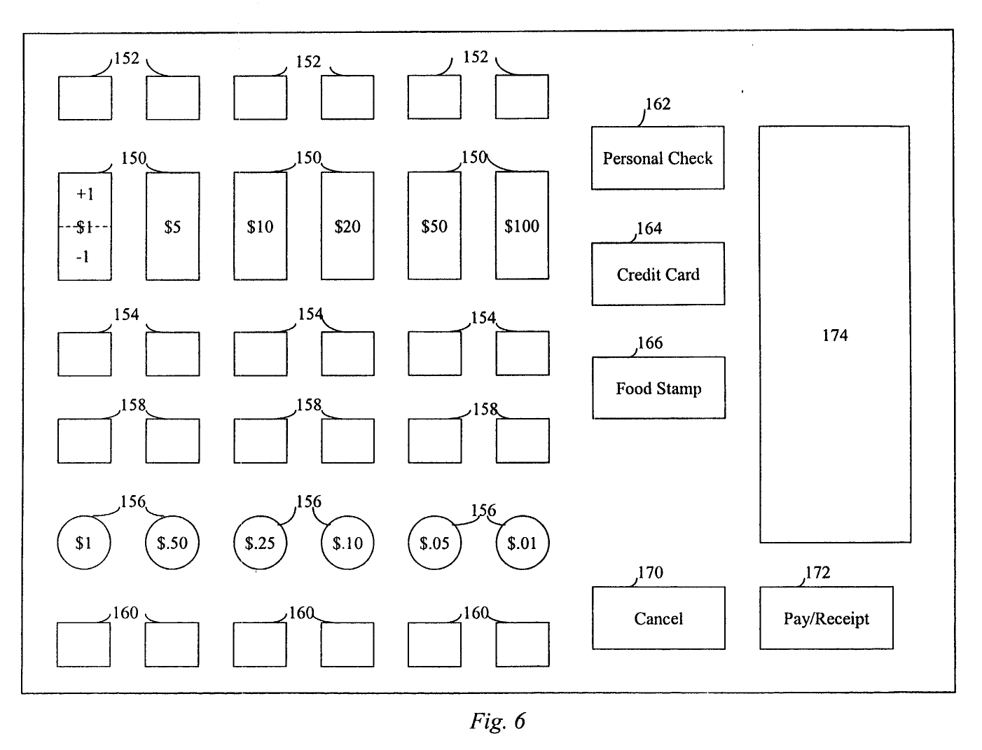

FIG. 6 shows a display screen from another embodiment of the program of the present invention. The display screen of FIG. 6 is a cash inventory screen displayed on the cash register which helps track the exact amounts of each denomination of bills and coins contained within the cash register. The cash inventory screen of FIG. 6 is intended to be used with a touch-sensitive display screen although the invention is not limited to touch-sensitive display screens and other forms of implementation will be obvious to one of ordinary skill. The cash inventory screen includes in its upper half a row of bill-shaped rectangles 150, or bill keys, indicating denominations for bills. Each bill key represents a different bill, in this example, 1's, 5's, 10's, 20's, 50's and 100's. A dotted line in the leftmost bill key 150 indicates that each bill key 150 has an upper and lower region. If the operator touches the upper region, this increments a counter that tracks the number of bills of that denomination that have been tendered by a customer in the transaction. Touching the lower region of the bill key 150 decrements the counter. Immediately above each bill key is a counter key 152 that displays to the operator the number of each denomination that the operator has indicated has been received for the transaction. Below the row of bill keys is a row of change designator keys 154 which will be described below. In the bottom half of the cash inventory screen is a row of circles representing coin denominations 156, or coin keys, including one dollar, fifty cents, twenty-five cents, ten cents, five cents and one cent. The coin keys 156 act in the same manner as described for the bill keys 150. Above the row of coin keys 156 is a row of coin counter keys 158 which operate in the same manner as described with respect to the bill counter keys. Below the coin keys is a row of change designator keys 160. In a column on the right of the cash inventory screen is a series of keys that indicate other than cash has been tendered for the sale, including a personal check key 162, credit card key 164, and food stamp key 166. Also present is a cancel key 170 and a pay/receipt key 172. Finally to the far right is a display area 174.

In operation, the cash register presents a main screen (not shown) that allows the operator to total up a transaction for goods purchased. That main screen will identify particular products available for purchase, numeral keys to manually enter a purchase price, or both, as is well known in the art. Goods transacted may also be entered using well known optical bar code scanning devices. When the operator hits a “total” key on the main screen, the cash inventory screen of FIG. 6 is presented. The operator can then indicate the exact denominations presented for tender by touching the top or bottom half of the appropriate bill keys 150, coin keys 156, and referring to the related counter keys 152 and 158. Once the denominations have been entered, the operator hits the pay/receipt key 172 and the change designators 154 and 160 respectively, indicate the numbers of each denomination of bills and coins that should be returned to the customer. Alternatively, the cash register can be connected to a standard coin drop mechanism, well known in the art, which will automatically dispense the appropriate coins leaving only the bills to be presented by the operator. If the cancel key 170 has been depressed, then the cash register display will return to the main screen (not shown). If any of the alternate tender methods such as check or credit card are used, then the operator touches the appropriate key and the cash inventory screen is bypassed. The transaction would then be completed as a non-cash transaction as is well understood in the art. Once the transaction is zeroed out and complete, the cash register returns to the main screen.

By using the cash inventory screen the cash register can track every denomination of cash and coin as it enters and leaves the drawer rather than allowing the employee to have control of the money in the drawer. This allows the computer program to track and detail which denominations should be present at the end of a shift, and allows the store manager to see which denominations present a problem and also which employees consistently vary from the totals computed by the register.

Although the invention has been described with reference to preferred embodiments illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A computer implemented method of detecting cash register employee theft comprising the steps of:
recording cash register transactions during a time period;
associating each recorded cash register transaction with an employee;
calculating the employee performance with respect to at least one cash register transaction data category; and
comparing the calculated employee performance to a second calculated employee performance for the at least one transaction data category.

2. The computer implemented method of claim 1 wherein the step of comparing comprises graphing the calculated employee performance and the second calculated employee performance.

3. The computer implemented method of claim 1 wherein the second calculated employee performance comprises a plurality of calculated employee performances for the at least one transaction data category taken from the same time period from previous work days.

4. The computer implemented method of claim 1 wherein the second calculated employee performance comprises an average of all recorded employee performances for the at least one transaction data category from a selected time period.

5. The computer implemented method of claim 1 wherein the at least one transaction data category is selected from the group comprising
overages and shortages, average no sales per customer, average of voids per customer, average refunds per customer, average void amount per customer, average refund amount per customer, average customers per hour, average number of gallons of gasoline per hour, average taxable sales per customer, average taxable sales per hour, average sales with fuel, average taxable sales per shift, average cigarette units per customer, cigarette volume, average lottery sales per total sales, or average time per transaction.

6. A computer implemented method of identifying cash register employee theft comprising the steps of:
storing cash register transaction data in a database, the data comprising an employee PIN and a transaction completion time;
calculating from the stored transaction data at least one transaction data type for the employee PIN from a selected time shift;
comparing the at least one transaction data type to a standard for the selected time shift; and
assigning a score to the employee PIN based on the comparison.

7. The computer implemented method of claim 6 wherein,
the standard is calculated by averaging the at least one transaction data type for the selected time shift for a number of previously stored shifts.

8. The computer implemented method of claim 6 wherein the at least one transaction data type is selected from the group comprising
overages and shortages, average no sales per customer, average of voids per customer, average refunds per customer, average void amount per customer, average refund amount per customer, average customers per hour, average number of gallons of gasoline per hour, average taxable sales per customer, average taxable sales per hour, average sales with fuel, average sales without fuel, average cigarette units per customer, cigarette volume, average lottery sales per customer, or average time per transaction.

9. The computer implemented method of claim 6 wherein the score is assigned based on the amount of deviation from the standard.

10. The computer implemented method of claim 9 wherein the score is assigned based on the amount of deviation from the standard for a plurality of transaction data types.

11. A computer programmed to identify possible employee theft comprising:
means for identifying an employee operating a cash register;
means for receiving and storing transaction data generated by the cash register;
means for calculating the employee's performance with respect to at least one type of the transaction data; and
means for comparing the employee performance with other employee performances.

12. The apparatus of claim 11 wherein the cash register comprises the programmed computer.

13. The apparatus of claim 11 wherein the programmed computer is linked to the cash register by a local area network.

14. The apparatus of claim 11 wherein the programmed computer is linked to the cash register via a wide area network.

15. A computer implemented method of controlling cash inventory in a cash register comprising the steps of:
tracking an inventory of cash denominations;
recording each cash denomination amount tendered by a customer during a transaction; and
indicating each cash denomination amount to tender as change to complete the transaction.

16. The method of claim 15 further comprising the step of automatically dispensing denominations as change for the transaction.

17. The method of claim 16 wherein the step of automatically dispensing denominations comprises automatically dispensing coins as change.

18. The method of claim 15 further comprising the step of providing a key to optionally indicate other than cash has been tendered in the transaction.

19. A computer programmed to control the cash inventory in a cash register comprising:
means for tracking an inventory of cash denominations;
means for indicating each cash denomination amount tendered by a customer during a transaction; and
means for indicating each cash denomination amount to tender as change to complete the transaction.

20. The apparatus of claim 19 further comprising an automatic coin dispenser coupled to the computer for dispensing the correct number of each denomination of coins required to complete the transaction.
